(19) United States
(12) Patent Application Publication
(10) Pub. No.: US 2007/0161369 A1
(43) Pub. Date: Jul. 12, 2007

(54) Methods for Intelligent Number Dialing Assistance and Related Marketing Techniques

(75) Inventors: Kumar K. Vishwanathan, Windham, NH (US); Prakash R. Iyer, Andover, MA (US); Rangamani Sundar, Windham, NH (US)

Correspondence Address: EDELL, SHAPIRO & FINNAN, LLC, 1901 RESEARCH BOULEVARD, SUITE 400, ROCKVILLE, MD, 20850, US

(73) Assignee: ENVIO NETWORKS INC., Andover, MA (US)

(21) Appl. No.: 11/622,094

(22) Filed: Jan. 11, 2007

Related U.S. Application Data
(60) Provisional application No. 60/757,895, filed on Jan. 11, 2006.

(51) Int. Cl. H04M 3/00

(52) U.S. Cl. 455/418

(57) ABSTRACT

A method is provided for assisting a mobile communication device user in entering a phone number for which a call is desired to be placed. When a user enters the alphanumeric characters upon initiating a calling session, the characters are analyzed together with criteria information to generate a list of a list of candidate or suggested phone numbers for presentation to the mobile device user. The mobile device user may then select a phone number from the list to execute the phone call. The intelligence to generate the list of candidate phone numbers may reside in a computing device (e.g., server) remote from the mobile communication device and connected to the network infrastructure equipment through which the mobile device communicates, or may reside in the mobile device itself. In the latter case, the mobile device may receive updates to the criteria information used to generate the list of candidate phone numbers.

### RELATED APPLICATION

This application claims priority to U.S. Provisional Application No. 60/757,895, filed Jan. 11, 2006, the entirety of which is incorporated herein by reference.

### FIELD OF THE INVENTION

The present invention is directed to mobile communication devices and services, and more particularly to delivering context based multiple concurrent applications or services to a mobile communication device.

### BACKGROUND OF THE INVENTION

Mobile communication devices, e.g. cellular phones, are becoming more data centric and less voice centric and the modern mobile lifestyle is changing rapidly. Indeed, in many countries, the mobile phone is the “primary screen” in the household instead of a laptop or desktop computer.

Nevertheless, the context of a mobile device user's activity is known by network entities and this contextual knowledge can be used to improve the mobile device user's experience. One user function on a mobile communication device that can be exploited to deliver additional features and services is the simple entry of the alphanumeric characters of a phone number for a call to be placed.

Accordingly, what is needed are ways to improve the experience of a mobile communication device user in connection entering a phone number into the mobile device when initiating a call to a destination party.

### SUMMARY OF THE INVENTION

Briefly, a method is provided for assisting a mobile communication device user in entering a phone number for which a call is desired to be placed. When a user enters the alphanumeric characters upon initiating a calling session, the characters are analyzed together with criteria information to generate a list of a list of candidate or suggested phone numbers for presentation to the mobile device user. The mobile device user may then select a phone number from the list to execute the phone call. The intelligence to generate the list of candidate phone numbers may reside in a computing device (e.g., server) remote from the mobile communication device and connected to the network infrastructure equipment through which the mobile device communicates, or may reside in the mobile device itself. In the latter case, the mobile device may receive updates to the criteria information used to generate the list of candidate phone numbers. The criteria information may include one or more of: a list of numbers frequently called by the mobile device user based on the user's call history pattern; the current geographical location of the mobile device user; a list of most frequently called business in the geographical area of the mobile device user; demographics of the user (e.g., age, sex, interests, businesses related to the frequently called numbers, etc.); a list of certain business entities (in the geographical area of the mobile device user) that have marketing and advertisement distribution agreements or other fee-based arrangements with a service provider, in order to promote their goods/services to users of mobile communication devices.

Objects and advantages of the techniques described herein will become more readily apparent when reference is made to the following description taken in conjunction with the accompanying drawings.

### BRIEF DESCRIPTION OF THE DRAWINGS

FIG. 1 is a high level block diagram showing a mobile communication system that is enhanced according to the techniques of the invention described herein to deliver concurrent applications to mobile communication devices.

FIG. 2 is a high level data flow diagram showing a concurrency application server that communications with a library component in a mobile device according to the present invention.

FIG. 3 is a block diagram of a mobile communication useful in accordance with the embodiments of the present invention.

FIG. 4 is a block diagram of the software architecture of the concurrency application system according to the present invention.

FIG. 5 is a flow chart for a method for assisting a user in entering and selecting a phone number for which a call is to be placed on behalf of the mobile communication device user.

FIG. 6 is a diagram depicting how a list of candidate numbers may be displayed to a mobile communication device user according to one embodiment.

FIG. 7 is a flow chart for a method according to an alternative embodiment.

### DETAILED DESCRIPTION

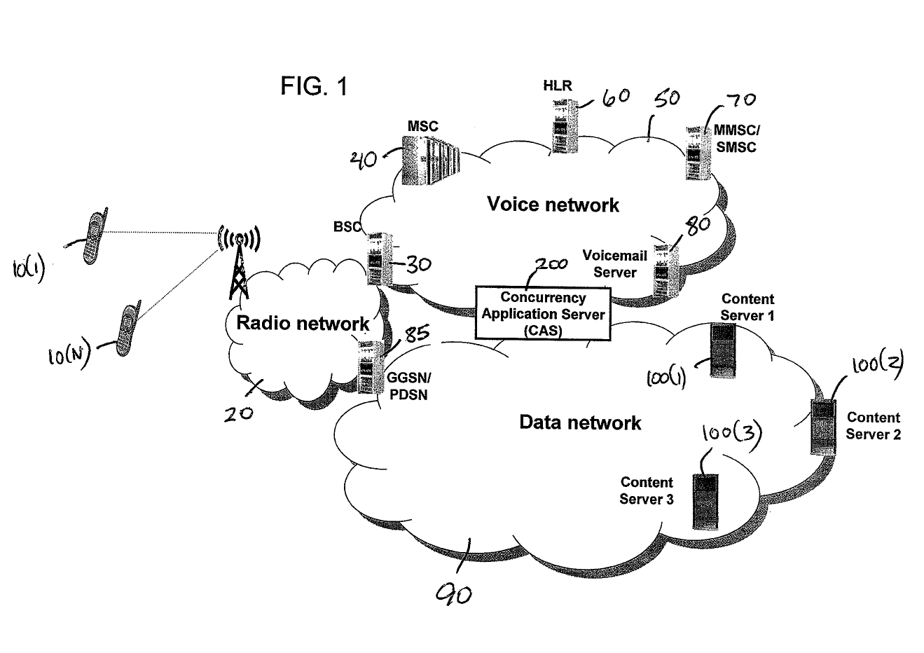

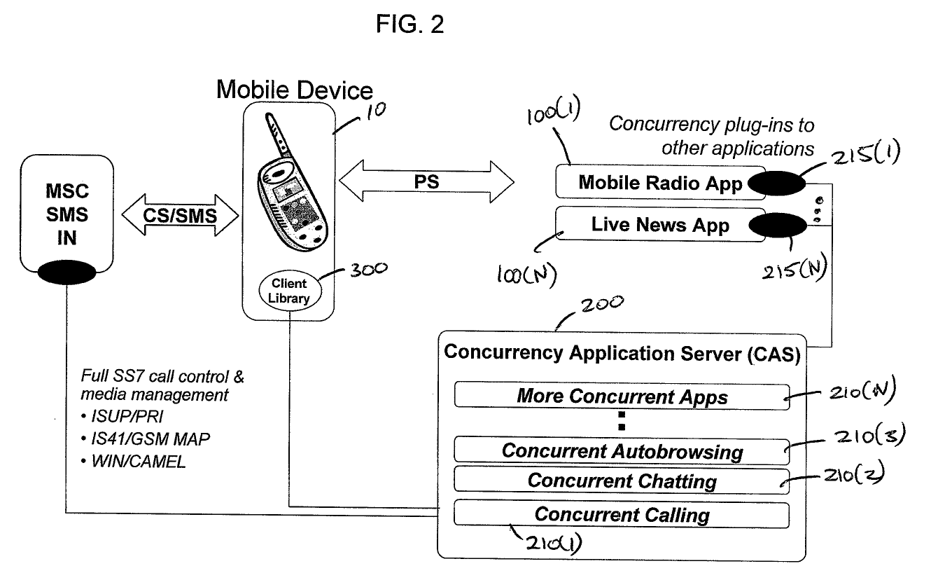

Referring first to FIGS. 1 and 2, the system and method for delivering digital content to mobile devices will be described. The mobile communication devices are shown at reference numeral 10(1) to 10(N) and may be cellular phone or other wireless communication devices that have sufficient display and user interface capability beyond simple telephony functions. Such devices are currently available and they have capabilities including mobile web browsing, mobile instant messaging and related capabilities. However, there is no capability heretofore known for providing concurrent applications to the mobile communication device so that the user can be placing or having a voice call and concurrently receiving other content or engaging in another communication related activity that is displayed on the display screen of the mobile device, or vice versa.

As is known in the art, mobile communication devices 10(1)-10(N) achieve a wireless radio communication link via a radio network 20 to base station control centers (BSCs) 30 and the BSCs 30 are in turn connected to a mobile switching center (MSC) 40 that is part of a voice network 50. Also in the voice network 50 is a home location register (HLR) 60 and a multimedia messaging service center/short message service center (MMSC/SMSC) 70 and a voicemail server 80. The MMSC/SMSC 70 handles processing of data messages to/from a mobile communication device. The radio network 20 is also connected to a data or packet network 90 by a GSM gateway serving node (GGSN)/packet data serving node (PDSN) 85. The data network 90 may include content servers 100(1), 100(2) and 100(3) that are accessible via the WWW for digital content.

According to the present invention, a mobile content system is provided that comprises a concurrency application server (CAS) 200 and a small client library 300 also called a concurrency application plug-in that resides in the mobile devices 10(1) to 10(N). The CAS 200 interfaces with equipment in the voice network 50 and equipment in the data network 90, e.g., the Internet. A mobile device 10(i) equipped with the concurrency application plug-in is said to be a concurrency-enabled mobile device. Thus, any currently available or hereinafter developed mobile device having the aforementioned user interface capabilities may be made concurrency-enabled by installing the client library 300 or otherwise configured with the functionality of the client library 300 as described herein. For example, the client library functionality may made part of the operating system of a mobile device.

The CAS 200 comprises an interface function (described hereinafter) that detects incoming calls or communication sessions that may be originate from an MSC or MMSC/SMSC. Depending on which concurrent applications the mobile device user has subscribed, the CAS 200 activates a mobile application. The CAS 200 comprises a plurality of mobile applications 210(1) to 210(N) that can be running concurrently in cooperation with a client library 300 on any number of mobile devices 10. Examples of mobile applications include a voice calling application 210(1), voice mail application 210(2), chatting application 210(3) and autobrowsing application 210(4). Additional mobile applications are described hereinafter. The mobile applications 210(1) to 210(N) may interface with third party applications 110(1) to 110(N) which may include, for example, a mobile radio application 110(1) and a live news application 110(N), as well as a mobile gaming application 120(1). The CAS 200 comprises concurrent application plug-ins 215(1) to 215(M) to enable interaction between the CAS applications and the third party applications.

A concurrent mobile application may be initiated by the CAS 200 as explained above or by the mobile device as well. For example, the client library 300 on the mobile device may activate a mobile application based on an incoming call or certain incoming message notifications. Thus, the mobile device or the CAS 200 may detect the need for concurrency and activate a mobile application concurrent with an already activated mobile application.

The functions of the CAS 200, such as the content delivery functions described herein, may be embodied by one or more computer program instructions that, when executed by computer processor, cause the computer processor to perform the functions that are described herein.

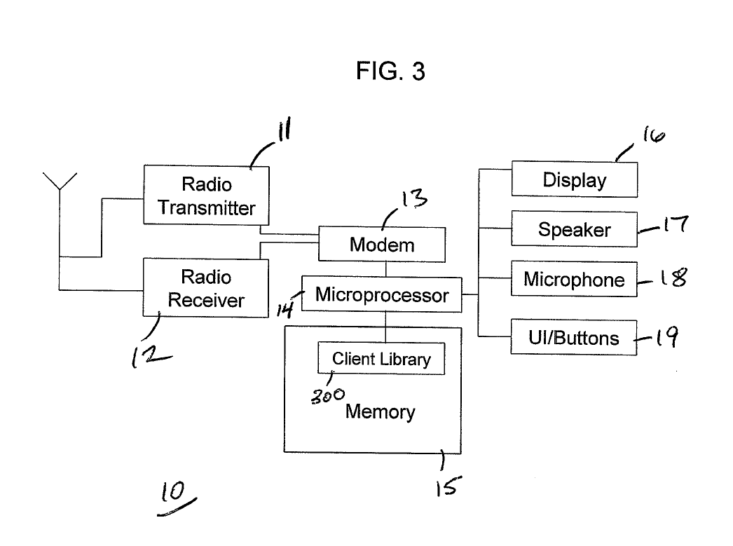

FIG. 3 illustrates a block diagram of a mobile device 10 according to one embodiment. The mobile device 10 comprises a radio transmitter 11, a radio receiver 12, a modem (baseband signal processor) 13, microprocessor 14, memory 15 and a variety of user interface components such as a display 16, speaker 17, microphone 18 and user interface buttons 19. The functions of many of the components are well known in the art and are therefore not described in detail herein. The client library 300 is installed in the memory 15. In addition to the client library 300, the memory 15 stores other software programs that are executed by the microprocessor 14 to provide the various mobile device functions to the user and coordinate cooperation with the CAS 200. The mobile device 10 need have only one instance each of a radio transmitter 11 and a radio receiver 12 to provide for multiple concurrent mobile applications to the device user. No modification to the hardware of a mobile device is necessary to achieve the concurrent mobile application functionality described herein. Moreover, no modification of the over-the-air communication protocol (between a mobile device and the radio network 20) is necessary to provide the concurrent application functionality described herein.

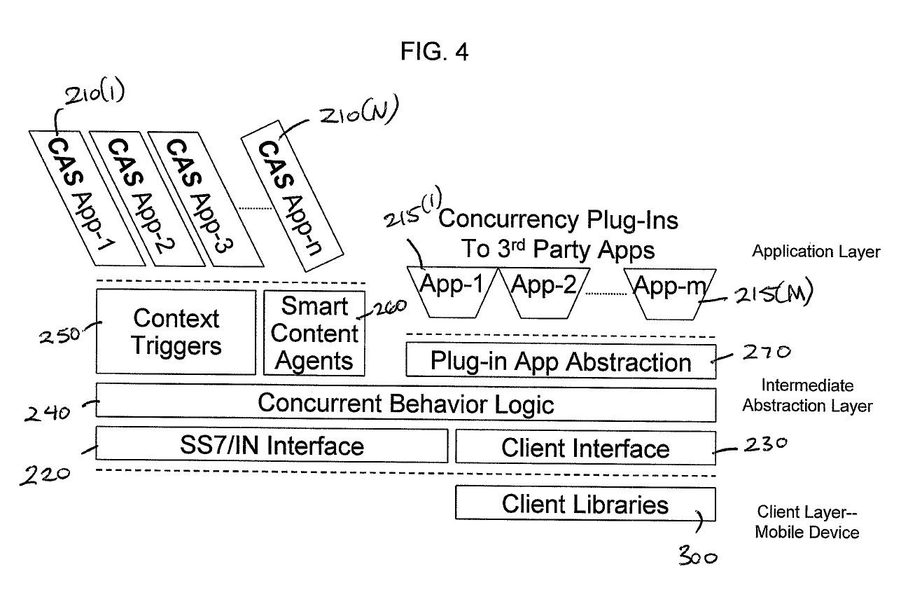

FIG. 4 illustrates an example of a software architecture for the concurrency application system functionality. As mentioned above, at the client layer there is a client library (concurrency application plug-in enabler) 300 that resides in the mobile device 10 that can activate an application while others are already active on the mobile device 10 and can switch an active application between the foregoing and background, either in response to a user control or automatically.

At an intermediate abstraction layer there is a SS7/IN interface function 220 and a client interface function 230. The SS7/IN interface function 220 detects call context information from a mobile device call. Call context parameter information includes, but is not limited to, information such as the mobile device ID, telephone number of the mobile device, the number called by the mobile device, etc., obtained from the MSC and location of the mobile device or other information obtained from or via the GGSN/PDSN 85. In addition, the client interface function 230 receives any special data from the mobile device 10 and delivers concurrency application information or content to the mobile device 10 in the appropriate format depending on the capabilities of the mobile device. There is also a concurrent behavior logic function 240 that maintains a profile data file for each mobile device 10 as to the types of concurrent applications to be provided to a mobile device and parameters associated with the concurrent application, which applications are active or available on a particular mobile device, etc. Next, there are a context triggers function 250 and a smart content agents function 260. The context trigger function 250 determines what type of concurrent applications should be invoked for a mobile device based on the context of the current activity of the mobile device (type of call made, time of day of the call, location of the mobile device when a call is made, calling number of the call, duration of the call in progress, etc.). Other context triggers may be location based, such as the absolute location of a mobile device user as well as the proximity of one mobile device user to another mobile device user. The location information can be absolute GPS-based or relative RFID-based, technologies for which are known in the art and used or will be used in mobile communication networks and services. The smart content agents function 260 activates one or more concurrent applications to retrieve certain content relevant to the context of a mobile device call, under control of the context trigger function 250.

The appropriate one or more CAS applications (CAS App-1 to CAS App-n) 210(1) to 210(N) are called upon by the context trigger and smart content agents functions 250 and 260. In addition, there is a plug-in application abstraction function 270 that interfaces the concurrent behavior logic function 240 with one or more concurrency application plug-ins 215(1) to 215(M).

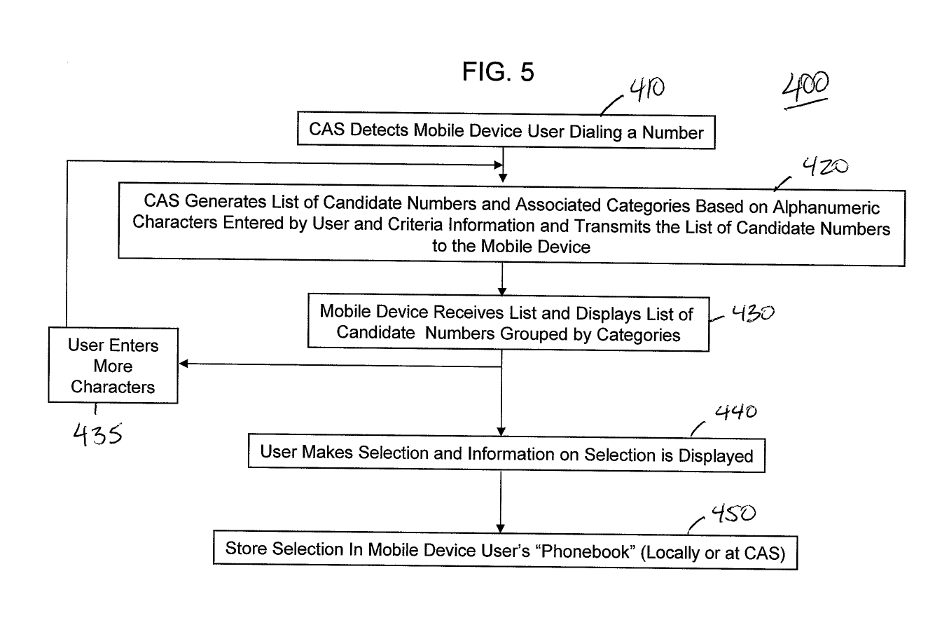

With reference to FIG. 5, a method is shown at 400 for intelligently assisting a mobile device user in more effectively entering a number for which a call is to be made from the mobile device handset.

In operation, a mobile device user begins to dial a phone number on the mobile device handset. The mobile device communicates to the CAS the alphanumeric characters (e.g., digits) dialed by the mobile device user and at 410, the CAS detects that the mobile user is dialing a phone number. The alphanumeric characters transmitted to the CAS represent at least a portion of a phone number for a call desired to be placed by a user of the mobile communication device. The alphanumeric characters may comprise a combination of numbers and/or letters that represent a portion (subset) of a complete phone number, or the entirety of a complete phone number.

At 420, the CAS examines the alphanumeric characters entered by the mobile device user to determine the areas of interest to the mobile device user. Based on various criteria described below, the CAS generates a list of suggested or candidate phone numbers and their associated categories using the alphanumeric characters entered by the mobile device user. The criteria information that the CAS uses to generate the list of candidate phone numbers may include one or more of:

a. A list of numbers frequently called by the mobile device user based on the user's call history pattern.

b. The current geographical location of the mobile device user.

c. A list of most frequently called business in the geographical area of the mobile device user

d. Demographics of the user (e.g., age, sex, interests, businesses related to the frequently called numbers, etc.)

e. A list of certain business entities (in the geographical area of the mobile device user) that have marketing and advertisement distribution agreements or other fee-based arrangements with the CAS in order to promote their goods/services to users of mobile communication devices.

Also at 420, the CAS transmits the list of candidate phone numbers to the mobile device.

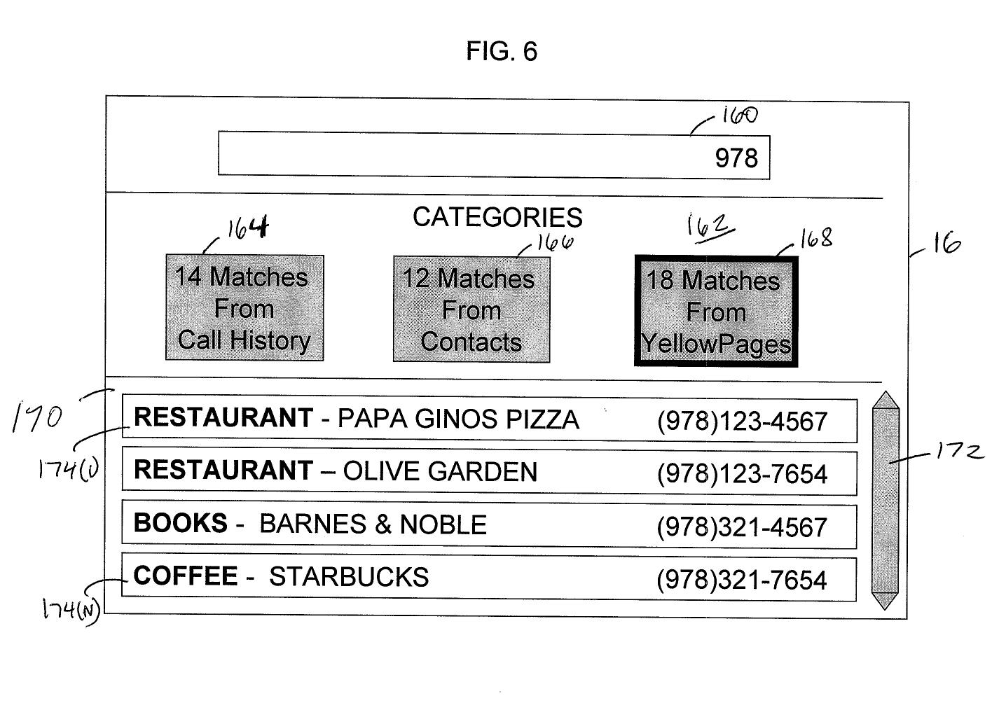

At 430, the mobile device receives the list of candidate numbers and their associated categories from the CAS and displays them grouped by categories to the mobile device user. Examples of categories of numbers are: (1) family; (2) friends; (3) office/work; (4) tennis group; (5) clients; (6) restaurants; (7) music venues, etc. As shown at 435, the mobile device user may continue to enter additional digits of the phone number from his/her memory or browse through the presented information to obtain to the correct number. As the user refines the numbers by adding more or changing digits, the CAS may update the candidate list and send an updated list, including additional information (more than once), to the mobile device to either override or modify the previous transmitted list, if needed. The list of candidate numbers and associated categories is updated and displayed. An example of how the list of candidate numbers and their categories can be displayed is shown in FIG. 6.

FIG. 6 shows an example of a display on which the list of candidate numbers found for the first three digits, “978”, of a phone number entered by a mobile device user. The entered alphanumeric characters forming all or part of the entered phone number are displayed in a first portion 160 of the display 16. The categories of candidate telephone numbers that are found from the entered alphanumeric characters are displayed in a second portion 162 of the display 16. In the example shown in FIG. 6, phone numbers for the digits “978” fall into at least 3 categories: “Call History”, “Contacts” and “Yellow Pages” and 14 matching phone numbers were found in the “Call History” category shown at graphical element 164, 12 matching phone numbers were found in the “Contacts” category as shown at graphical element 166 and 18 matching phone numbers were found in the “Yellow Pages” category shown at graphical element 168. The numbers for a particular category can be retrieved when the user selects the corresponding one of the graphical elements 164, 166 or 168. Thus, in the example shown in FIG. 6, the graphical element 168 is selected and the list of numbers 174(1) to 174(N) for the “Yellow Pages” category is displayed in a portion 170 of the display 16. There may be a scrolling function shown at 172 that enables a mobile device user to scroll through the displayed list of candidate phone numbers. For each number that is displayed, there is a text identifying the name of the party as well as a sub-category. For example, the item 174(1) in the list, again one of the 18 matching candidate numbers for the category “Yellow Pages”, is the name of the party “Papa Ginos Pizza” and the sub-category “Restaurant”. FIG. 6 is meant to show only an example of how the candidate phone numbers may be displayed. Other variations include displaying an icon representing a category of phone numbers, digital images for a category or sub-category or in place or in addition to the name text, etc.

Referring back to FIG. 5, At 440, the mobile device receives input from the user for a selection of a number in the candidate list. When the mobile device user finally chooses the number he/she would like to call, information about the called party (name, address etc.) may be displayed to the mobile device user, if available. This information may be collected from multiple sources. In addition, at this time the CAS may use this opportunity to retrieve and display other information (name, address and phone number) not per se directly related to the proposed called party, e.g., information for competing businesses in the same product or service as that associated with the selected phone number. At the mobile device user's request or automatically, the selected number and/or other collected information may be automatically stored at the CAS on behalf of the mobile device user, or stored locally at the mobile device as shown at 450.

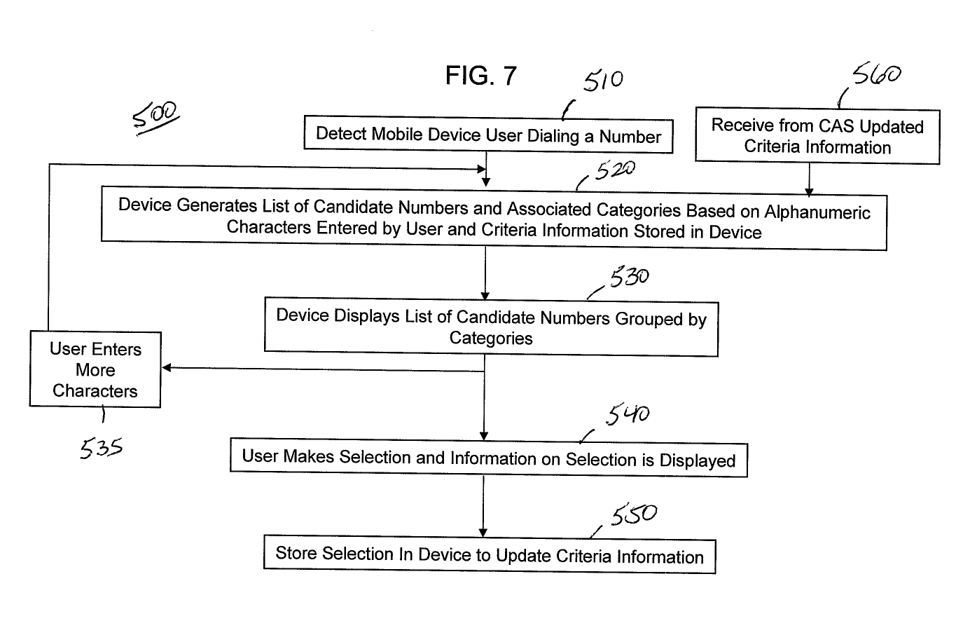

While the foregoing describes that the list is generated in network equipment, e.g., the CAS, and transmitted to the mobile communication device, it is also envisioned that a software application may reside on the mobile communication device that monitors alphanumeric characters entered by the mobile communication device user and uses a locally stored database of criteria information to generate the list of candidate numbers and categories as described above. FIG. 7 illustrates a flow chart for a method 500 performed when the mobile communication device itself includes a software function to perform the intelligent number dialing assistant function. This would avoid the need to transmit the list of candidate phone numbers to the mobile device each time a new phone call session is initiated.

At 510, the mobile device detects a user dialing alphanumeric characters of a phone number. At 520, the device generates a list of candidate numbers and associated categories based on the entered alphanumeric characters and criteria information that is stored in the mobile device. This is similar to step 420 shown in FIG. 5 and described above, except that it is performed by the processor in the mobile communication device, rather than by the CAS. At 530, the mobile device displays the list of candidate or suggested phone numbers to the user (such as shown in FIG. 6). At 540, the user makes a selection from the list and information associated with the selection is displayed, similar to step 440 in FIG. 5. At 550, mobile device stores information about the selection made by the user in order to update the criteria information. As shown at 535, the device may analyze the alphanumeric characters as new characters are entered by the user and modify or update the list of candidate numbers at 520. From time to time, at 560, the mobile device may receive from the CAS updated criteria information for storage in the mobile device and use at 520 when a user enters characters associated with a phone number. For example, the CAS may on a periodic basis (daily, weekly, monthly, etc.) transmit updates to the criteria information to be stored locally in the database that is accessed by the software application that monitors user entry of phone numbers/characters and generates the list of candidate phone numbers.

It should be understood that techniques described herein are applicable when a mobile device user has entered a portion or subset of a complete phone number (e.g., 1 or more out of the 10 necessary characters for a complete number) or after the mobile device user has entered all of the characters for a complete phone number.

The device and methods described herein may be embodied in other specific forms without departing from the spirit or essential characteristics thereof. The foregoing embodiments are therefore to be considered in all respects illustrative and not meant to be limiting.

What is claimed is:

1. A method for assisting a mobile communication device user in entering a phone number for which a call is desired to be placed, comprising:
a. accessing data that represents at least a portion of a phone number entered into a mobile communication device for a call to be placed by a user of the mobile communication device;
b. examining said data and generating a list of candidate phone numbers; and
c. displaying on the mobile communication device the list of candidate phone numbers.

2. The method of claim 1, and further comprising executing a phone call in response to user selection of a phone number from the list.

3. The method of claim 1, wherein (a) accessing comprises receiving at a computing device that is remote from the mobile communication device said data representing at least a portion of the phone number entered by the user, and wherein (b) examining is performed at the computing device, and further comprising transmitting data representing the list of candidate phone numbers to the mobile communication device.

4. The method of claim 1, wherein (a) accessing comprises monitoring alphanumeric characters entered by the user of the mobile communication device with a function residing on the mobile communication device.

5. The method of claim 4, wherein (b) comprises generating the list of candidate phone numbers based on said data representing at least a portion of the phone number entered by the user and criteria information comprising one or more of: (i) a call history pattern of the mobile communication device user; (ii) a geographical location of the mobile communication device; (iii) frequently called phone numbers in a geographical area of the mobile communication device; (iv) demographics of the mobile communication device user; and (v) entities that have entered into fee-based arrangements for access to users of mobile communication devices.

6. The method of claim 1, and further comprising displaying additional information when a selection is made from the list by the user, said additional information pertaining to competing businesses for similar products or services associated with the selected phone number.

7. The method of claim 1, and further comprising storing data representing the selected phone number.

8. The method of claim 7, wherein storing is performed at the mobile communication device or at a remote computing device on behalf of the mobile communication device.

9. The method of claim 1, wherein (b) generating comprises generating categories for the candidate phone numbers in the list.

10. The method of claim 1, wherein (b) comprises generating the list of candidate phone numbers based on said data representing at least a portion of the phone number entered by the user and criteria information comprising one or more of: (i) a call history pattern of the mobile communication device user; (ii) a geographical location of the mobile communication device; (iii) frequently called phone numbers in a geographical area of the mobile communication device; (iv) demographics of the mobile communication device user; and (v) entities that have entered into fee-based arrangements for access to users of mobile communication devices.

11. A system for assisting a mobile communication device user in entering a phone number for which a call is desired to be placed, comprising:
a. a mobile communication device comprising a user interface that allows a user to enter alphanumeric characters that make up a phone number for a call to be placed by a user of the mobile communication device, and a display; and
b. a computing device remote from said mobile communication device connected to wireless network equipment in order to receive data associated with operations on said mobile communication device, said computing device receiving data representing at least a portion of a phone number entered by the user of said mobile communication device, examining said data representing at least a portion of the phone number entered by the user and generating a list of candidate phone numbers, and transmitting said list of candidate phone numbers to said mobile communication device for display on said mobile communication device to said user.

12. The system of claim 11, wherein the computing device generates the list of candidate phone numbers based on criteria information comprising one or more of: (i) a call history pattern of the mobile communication device user; (ii) a geographical location of the mobile communication device; (iii) frequently called phone numbers in a geographical area of the mobile communication device; (iv) demographics of the mobile communication device user; and (v) entities that have entered into fee-based arrangements for access to users of mobile communication devices.

13. The system of claim 11, wherein the computing device stores data representing a selected phone number from the list in order to track calling history of said user.

14. The system of claim 11, wherein the computing device receives data from the mobile communication device when a selection is made from the list by the user, said additional information pertaining to competing businesses for similar products or services associated with the selected phone number.

15. A mobile communication device, comprising:
a. a user interface that allows a user to enter alphanumeric characters that make up a phone number for a call to be placed by a user of the mobile communication device;
b. a display; and
c. a controller coupled to said user interface and said display, said controller monitoring alphanumeric characters entered by the user of the mobile communication device forming at least a portion of a phone number and generating a list of candidate phone numbers based on said alphanumeric characters and criteria information comprising one or more of: (i) a call history pattern of the mobile communication device user; (ii) a geographical location of the mobile communication device; (iii) frequently called phone numbers in a geographical area of the mobile communication device; (iv) demographics of the mobile communication device user; and (v) entities that have entered into fee-based arrangements for access to users of mobile communication devices.

16. The mobile communication device of claim 15, wherein the controller generates categories for the candidate phone numbers in the list.

17. The mobile communication device of claim 15, and further comprising a memory that stores said criteria information.

18. The mobile communication device of claim 17, wherein said memory stores updated criteria information transmitted to said mobile communication device from a remote computing device.

19. A method for assisting a mobile communication device user in entering a phone number for which a call is desired to be placed, comprising:
a. accessing data that represents at least a portion of a phone number entered into a mobile communication device for a call to be placed by a user of the mobile communication device; and
b. generating a list of candidate phone numbers based on said data representing at least a portion of the phone number entered by the user and criteria information comprising one or more of: (i) a call history pattern of the mobile communication device user; (ii) a geographical location of the mobile communication device; (iii) frequently called phone numbers in a geographical area of the mobile communication device; (iv) demographics of the mobile communication device user; and (v) entities that have entered into fee-based arrangements for access to users of mobile communication devices.

20. The method of claim 19, and further comprising updating said criteria information based on phone numbers selected by the user.

21. The method of claim 19, and further comprising transmitting the list of candidate phone numbers to the mobile communication device.

22. The method of claim 19, wherein said generating is performed in said mobile communication device, and further comprising storing said criteria information in said mobile communication device.

23. The method of claim 22, and further comprising transmitting to said mobile communication device updates to said criteria information.
